(19) United States
(12) Patent Application Publication
(10) Pub. No.: US 2023/0197932 A1
(43) Pub. Date: Jun. 22, 2023

(54) NEGATIVE ACTIVE MATERIAL FOR RECHARGEABLE LITHIUM BATTERY AND RECHARGEABLE LITHIUM BATTERY INCLUDING SAME

(71) Applicant: SAMSUNG SDI CO., LTD., Yongin-si (KR)

(72) Inventors: Jaewon KIM, Yongin-si (KR); Yongseok KIM, Yongin-si (KR); Sojeong YU, Yongin-si (KR); Kyeu Yoon SHEEM, Yongin-si (KR); Jungjoon KIM, Yongin-si (KR); Jaehou NAH, Yongin-si (KR); Hyejin KIM, Yongin-si (KR); Eunjoo LEE, Yongin-si (KR)

(21) Appl. No.: 17/964,135

(22) Filed: Oct. 12, 2022

(30) Foreign Application Priority Data
Dec. 20, 2021 (KR) 10-2021-0183120

(51) Int. Cl. H01M 4/36; H01M 4/38; H01M 4/583; H01M 10/052

(52) U.S. Cl. CPC H01M 4/364; H01M 4/386; H01M 4/583; H01M 10/052; H01M 2004/027

(57) ABSTRACT

A negative active material for a rechargeable lithium battery includes a composite of porous silicon and amorphous carbon, the composite having macropores with a size of about 50 nm or more, and a porosity of about 15% to about 40%.

### CROSS-REFERENCE TO RELATED APPLICATION

This application claims priority to and the benefit of Korean Patent Application No. 10-2021-0183120, filed in the Korean Intellectual Property Office on Dec. 20, 2021, the entire contents of which are incorporated herein by reference.

### BACKGROUND

### 1. Field

Embodiments relate to a negative active material and a rechargeable lithium battery including the same.

### 2. Description of the Related Art

Recently, the rapid supply of electronic devices, e.g., mobile phones, laptop computers, and electric vehicles, which implement batteries, caused an increased demand for rechargeable batteries with relatively high capacity and light weight. Particularly, a rechargeable lithium battery has recently drawn attention as a driving power source for portable devices, as it has light weight and high energy density. Accordingly, research for improving performances of rechargeable lithium batteries is being actively undertaken.

For example, a rechargeable lithium battery may include a positive electrode and a negative electrode which include active materials capable of intercalating and deintercalating lithium ions, and an electrolyte. The rechargeable lithium battery generates electrical energy due to the oxidation and reduction reaction when lithium ions are intercalated and deintercalated into the positive electrode and the negative electrode.

The positive active material of the rechargeable lithium battery may include transition metal compounds, e.g., lithium cobalt oxide, lithium nickel oxide, and lithium manganese oxide. The negative active material of the rechargeable lithium battery may include a crystalline carbonaceous material, e.g., natural graphite or artificial graphite, or an amorphous carbon material.

### SUMMARY

According to an embodiment, a negative active material for a rechargeable lithium battery may include a composite of porous silicon and amorphous carbon having macropores with a size of about 50 nm or more and a porosity of about 15% to about 40%.

An amount of the amorphous carbon may be about 5 wt % to about 50 wt % based on a total of 100 wt % of the negative active material.

The porosity may be about 20% to about 40%.

The macropores may have a size of about 50 nm to about 300 nm.

An amount of the porous silicon may be about 50 wt % to about 95 wt % based on a total 100 wt % of the negative active material.

The composite of the porous silicon and the amorphous carbon may be prepared by mixing porous silicon with amorphous carbon and heat-treating.

Another embodiment provides a rechargeable lithium battery including a negative electrode including the negative active material, a positive electrode, and a non-aqueous electrolyte.

### BRIEF DESCRIPTION OF THE DRAWINGS

Features will become apparent to those of skill in the art by describing in detail exemplary embodiments with reference to the attached drawings, in which:

FIG. 1 is a schematic perspective view of a rechargeable lithium battery according to an embodiment.

FIG. 2 is a SEM photograph showing a procedure of obtaining porosity from the negative active material layer according to Example 4.

FIG. 3 is a SEM photograph showing a procedure of obtaining porosity from the negative active material layer according to Comparative Example 2.

FIG. 4 is a SEM photograph showing procedure of obtaining porosity from the negative active material layer according to Comparative Example 4.

FIG. 5 is a SEM photograph showing procedure of obtaining porosity from the negative active material layer according to Example 1.

FIG. 6 is a SEM photograph showing procedure of obtaining porosity from the negative active material layer according to Comparative Example 1.

FIG. 7 is a SEM photograph showing procedure of obtaining porosity from the negative active material layer according to Comparative Example 3.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present. Like reference numerals refer to like elements throughout.

In the specification, when a definition is not otherwise provided, the pore size refers to a pore size, e.g., an average pore size, determined via scanning electron microscope (SEM) cross-section analysis or a value obtained as a mode via Barrett-Joyner-Halenda (BJH) analysis obtained by measuring adsorption and desorption of nitrogen gas.

A negative active material for a rechargeable lithium battery according to an embodiment may include a composite of porous silicon and amorphous carbon. The negative active material may have macropores with a pore size, e.g., diameter, of about 50 nm or more and may have porosity of about 15% to about 40%. As such, the negative active material may have macropores with a pore size of about 50 nm or more, so that the side-reaction may be suppressed and the volume expansion caused from the charging and discharging may be effectively absorbed.

The negative active material may have the composite with the amorphous carbon so that the electron conductivity may be improved, thereby improving the initial efficiency of the negative active material.

The macropores may have a size, i.e., a pore size, of about 50 nm or more, e.g., about 50 nm to about 300 nm or about 100 nm to about 200 nm. If pores included in the negative active material layer were to have a size of less than 50 nm, for example, 2 nm or more and less than 50 nm, they would be classified as mesopores (rather than macropores), and volume expansion caused from charging and the discharging would not have been effectively absorbed. Further, the presence of large mesopores may cause an increase in the reaction area, so that the side reaction may not be suppressed.

In an embodiment, the porosity may be about 15% to about 40%, e.g., about 20% to about 40%. When the porosity is within the above range, the effect from inclusion of macropores with a size of about 50 nm or more may be effectively realized. If the porosity is less than about 15%, the volume expansion caused from the charging and the discharging may not be sufficiently absorbed. If the porosity is more than about 40%, safety of the porous structure may be decreased. Therefore, if the porosity is not about 15% to about 40%, the effect of improving the cycle-life characteristics and the initial efficiency of the rechargeable lithium battery may not be obtained, even if it includes macropores with a size of about 50 nm or more.

In an embodiment, the porosity is a value measured in the cross-section of the negative active material layer, e.g., may be obtained by separating silicon, amorphous carbon, and pores through a difference in contrast from a SEM photograph of the cross-section of the negative active material layer after the SEM photograph is measured.

When it is illustrated in more detail, the porosity may be obtained from the contrast difference in a portion corresponding to unit area, e.g., a unit area of about 3 μm X about 3 μm. For example, in the SEM photograph, the bright portion indicates silicon, the grey portion indicates amorphous carbon, and the dark portion indicates pores, so that the area % of the dark portion based on the total area may correspond to porosity in the SEM photograph.

In an embodiment, an amount of the porous silicon may be about 50 wt % to about 95 wt %, based on a total of 100 wt % of the negative active material. An amount of the amorphous carbon may be about 5 wt % to about 50 wt %, based on a total of 100 wt % of the negative active material. When the amounts of the porous silicon and the amorphous carbon in the negative active material are satisfied in the above range, suitable electrical conductivity may be exhibited, thereby exhibiting excellent charge and discharge efficiency.

The negative active material may be prepared by mixing porous silicon and amorphous carbon, e.g., physically dry-mixing, and heat-treating, e.g., to form a heat-treated composite. The physical mixing of the porous silicon and the amorphous carbon ensures electrical conductivity derived from using the amorphous carbon and maintains macropores with a size of about 50 nm or more.

If an amorphous carbon liquid in which amorphous carbon is added to a solvent is used to mix with the porous silicon, the amorphous carbon is immersed into pores of the porous silicon to decrease pore size and porosity.

A mixing ratio of the porous silicon and the amorphous carbon may be about 95:5 weight ratio to about 50:50 weight ratio, e.g., about 90:10 weight ratio to about 70:30 weight ratio. When the mixing ratio of the porous silicon and the amorphous carbon is within the above range, excellent electrical conductivity may be exhibited, and the macropore structure may be well maintained, thereby properly maintaining the shape of the composite. Furthermore, the mixing ratio within the above range allows to maintain macropores with a size of about 50 nm or more and to obtain the active material with porosity of about 15% to about 40%.

The heat-treatment may be performed at about 700° C. to about 1000° C. The heat-treatment may be performed under an inert atmosphere such as nitrogen gas and argon gas, and for about 1 hour to about 5 hours.

When the heat-treatment is performed under the above conditions, the macropores may be well maintained and the electrical conductivity of the porous silicon may be improved. When the heat-treatment is performed under the above conditions, a positive active material having porosity of about 15% to about 40%, while maintaining macropores having a size of about 50 nm or, may be prepared.

The porous silicon may have macropores with a size of about 50 nm or more, e.g., about 50 nm to about 300 nm. As long as porous silicon has macropores of the above size, a commercially available porous silicon or porous silicon prepared by any suitable procedure may be used. In addition, the porous silicon may have porosity of about 5% to about 50%.

The porous silicon may be prepared by mixing silicon and a pore former into an agglomerate. The pore former may be removed from the resultant agglomerated product. A mixing ratio of the silicon and the pore former may be about 2:1 to about 10:1 weight ratio, e.g., about 2:1 to about 7:1 weight ratio. When the mixing ratio of the silicon and the pore former is within the above range, porous silicon with desired porosity may be prepared.

The pore former may be, e.g., sodium chloride (NaCl), potassium chloride (KCl), or polystyrene beads, and may have a size of about 50 nm. The mixing with the pore former may be performed in a solvent, and the solvent may be, e.g., water, alcohol, acetone, toluene, N-methyl-2-pyrrolidone, tetrahydrofuran, or a combination thereof.

The agglomeration may be performed by, e.g., spray drying, and the removal of the pore former may be performed by, e.g., adding the agglomerated product in a solvent. The solvent may be, e.g., water, alcohol, acetone, or a combination thereof.

According to an embodiment, the porous silicon may also be prepared by oxidizing a silicon-based compound, e.g., Mg₂Si, to prepare a mixture, e.g., MgO and Si, followed by etching the mixture by using an acid, e.g., hydrochloric acid, to remove MgO. The oxidation may be performed by heat treating, and the heat-treatment may be performed under, e.g., an air atmosphere, a nitrogen atmosphere, or a carbon dioxide atmosphere. The heat-treatment may be performed at about 550° C. to about 650° C. The heat-treatment may be performed for about 10 hours to about 20 hours.

The etching may be performed by etching the mixture by using an acid, e.g., hydrochloric acid. For example, the mixture may be immersed in the acid. The immersion may be performed for a suitable time for substantially completely dissolving the MgO, e.g., about 8 hours to about 10 hours.

The amorphous carbon may be, e.g., soft carbon, hard carbon, mesophase pitch carbide, sintered cokes, or a combination thereof.

An embodiment provides a rechargeable lithium battery including a negative electrode, a positive electrode, and an electrolyte.

The negative electrode may include a current collector and a negative active material layer including the negative active material according to an embodiment. The negative active material layer of an embodiment is prepared by using the composite of porous silicon and the amorphous carbon as the negative active material, so that the amorphous carbon may be uniformly presented throughout the negative active material layer.

The negative active material layer may further include a crystalline carbon negative active material. The crystalline carbon negative active material may have an unspecified shape or may be sheet-shaped, flake-shaped, spherically-shaped, or fiber-shaped. The crystalline carbon negative active material may be a natural graphite or an artificial graphite.

When the negative active material layer includes the negative active material according to an embodiment as a first negative active material, and the crystalline carbon negative active material as a second negative active material, the first negative active material is positioned between the second negative active material particles to properly contact the second negative active material, thereby more effectively inhibiting the expansion of the negative electrode. Herein, the mixing ratio of the first negative active material to the second negative active material may be a weight ratio of about 1:99 to about 40:60. When the first negative active material and the second negative active material are mixed and used in the above range, the current density of the negative electrode may be further improved and the thin film electrode may be prepared.

Furthermore, the first active material including silicon in the negative electrode may be more uniformly presented. Thus, the negative electrode expansion may be more effectively suppressed.

In the negative active material layer, the amount of the negative active material may be about 95 wt % to about 99 wt %, based on the total weight of the negative active material layer.

The negative active material layer may include a binder, and may further include a conductive material. In the negative active material layer, the amount of the binder may be about 1 wt % to about 5 wt %, based on the total weight of the negative active material layer. Furthermore, when the conductive material is further included, about 90 wt % to about 98 wt % of the negative active material, about 1 wt % to about 5 wt % of the binder, and about 1 wt % to about 5 wt % of the conductive material may be used.

The binder improves binding properties of negative active material particles with one another and with a current collector. The binder may be a non-aqueous binder, an aqueous binder, or a combination thereof.

Examples of the non-aqueous binder may be an ethylene propylene copolymer, polyacrylonitrile, polystyrene, polyvinylchloride, carboxylated polyvinylchloride, polyvinylfluoride, polyurethane, polytetrafluoroethylene, polyvinylidene fluoride, polyethylene, polypropylene, polyamide imide, polyimide, or a combination thereof.

Examples of the aqueous binder may be a styrene-butadiene rubber, an acrylated styrene-butadiene rubber (ABR), an acrylonitrile-butadiene rubber, an acrylic rubber, a butyl rubber, a fluorine rubber, an ethylene oxide-containing polymer, polyvinyl pyrrolidone, polyepichlorohydrin, polyphosphazene, an ethylene propylene diene copolymer, polyvinylpyridine, chlorosulfonated polyethylene, latex, a polyester resin, an acrylic resin, a phenolic resin, an epoxy resin, polyvinyl alcohol, or a combination thereof.

When the aqueous binder is used as a negative electrode binder, a cellulose-based compound may be further used to provide viscosity as a thickener. The cellulose-based compound includes one or more of carboxymethyl cellulose, hydroxypropyl methyl cellulose, methyl cellulose, or alkali metal salts thereof. The alkali metal may be Na, K, or Li. The thickener may be included in an amount of about 0.1 parts by weight to about 3 parts by weight, based on 100 parts by weight of the negative active material.

The conductive material is included to provide electrode conductivity, and any electrically conductive material may be used as a conductive material unless it causes a chemical change. Examples of the conductive material may be a carbon-based material, e.g., natural graphite, artificial graphite, carbon black, acetylene black, ketjen black, a carbon fiber, and the like; a metal-based material of a metal powder or a metal fiber including, e.g., copper, nickel, aluminum, silver, and the like; a conductive polymer, e.g., a polyphenylene derivative; or a mixture thereof.

The current collector may include at least one of a copper foil, a nickel foil, a stainless steel foil, a titanium foil, a nickel foam, a copper foam, a polymer substrate coated with a conductive metal, and a combination thereof.

The negative electrode according to an embodiment may be prepared by mixing the negative active material, the binder, and optionally, the conductive material in a solvent to prepare an active material composition and coating the active material composition on the current collector. The solvent may be, e.g., water.

The positive electrode may include a current collector and a positive active material layer formed on the current collector.

The positive electrode active material may include lithiated intercalation compounds that reversibly intercalate and deintercalate lithium ions. For example, one or more composite oxides of a metal, e.g., one of cobalt, manganese, nickel, and a combination thereof, and lithium may be used. More specifically, the compounds represented by one of the following chemical formulae may be used. LiₐA_{1-b}X_{b}D¹₂ (0.90≤a≤1.8, 0≤b≤0.5); LiₐA_{1-b}X_{b}O_{2-c1}D¹_{c1} (0.90≤a≤1.8, 0≤b≤0.5, 0≤c1≤0.05); LiₐE_{1-b}X_{b}≤O_{2-c1}D¹_{c1} (0.90≤a≤1.8, 0≤b≤0.5, 0≤c1≤0.05); LiₐE_{2-b}X_{b}O_{4-c1}D¹_{c1} (0.90≤a≤1.8, 0≤b≤0.5, 0≤c1≤0.05); Liₐ≤Ni_{1-b-c}Co_{b}X_{c}D¹_{α} (0.90≤a≤1.8, 0≤b≤0.5, 0≤c≤0.5, 0<α≤2); LiₐNi_{1-b-c}Co_{b}X_{c}O_{2-α}T_{α} (0.90≤a≤1.8, 0≤b≤0.5, 0≤c≤0.5, 0<α<2); LiₐNi_{1-b-c}Co_{b}X_{c}O_{2-α}T₂ (0.90≤a≤1.8, 0≤b≤0.5, 0≤c≤0.5, 0<α<2); LiₐNi_{1-b-c}Mn_{b}X_{c}D¹_{α} (0.90≤a≤1.8, 0≤b≤0.5, 0≤c≤0.5, 0<α<2); LiₐNi_{1-b-c}Mn_{b}X_{c}O_{2-α}T_{α} (0.90≤a≤1.8, 0≤b≤0.5, 0≤c≤0.5, 0<α<2); LiₐNi_{1-b-c}Mn_{b}X_{c}O_{2-α}T₂ (0.90≤a≤1.8, 0≤b≤0.5, 0≤c≤0.5, 0<α<2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}Mn_{d}GₑO₂ (0.90≤a≤1.8, 0≤b≤0.9, 0≤c≤0.5, 0≤d≤0.5, 0.001≤e≤0.1); LiₐNiG_{b}O₂ (0.90≤a≤1.8, 0.001≤b≤0.1) LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); QO₂; QS₂; LiQS₂; V₂O₅; LiV₂O₅; LiZO₂; LiNiVO₄; Li_{(3-f)}J₂(PO₄)₃ (0≤f≤2); Li_{(3-f)}Fe₂(PO₄)₃ (0≤f≤2); LiₐFePO₄ (0.90≤a≤1.8)

In the above chemical formulae, A is selected from Ni, Co, Mn, and a combination thereof; X is selected from Al, Ni, Co, Mn, Cr, Fe, Mg, Sr, V, a rare earth element, and a combination thereof; D¹ is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

Also, the compounds may have a coating layer on the surface, or may be mixed with another compound having a coating layer. The coating layer may include at least one of, e.g., at least one consisting of, an oxide of a coating element, a hydroxide of a coating element, an oxyhydroxide of a coating element, an oxycarbonate of a coating element, and a hydroxyl carbonate of a coating element. The coating element included in the coating layer may include, e.g., Mg, Al, Co, K, Na, Ca, Si, Ti, V, Sn, Ge, Ga, B, As, Zr, or a mixture thereof. The coating layer may be disposed in a method having no adverse influence on properties of a positive electrode active material by using these elements in the compound, e.g., the method may include spray coating, dipping, and the like.

In the positive electrode, a content of the positive active material may be about 90 wt % to about 98 wt %, based on the total weight of the positive active material layer.

In an embodiment, the positive active material layer may further include a binder and a conductive material. Herein, each of the binder and the conductive material may be, e.g., independently, included in an amount of about 1 wt % to about 5 wt %, based on the total amount of the positive active material layer.

The binder improves binding properties of positive electrode active material particles with one another and with a current collector. Examples of the binder may be polyvinyl alcohol, carboxymethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, styrene butadiene rubber, acrylated styrene butadiene rubber, an epoxy resin, nylon, and the like.

The conductive material is included to provide electrode conductivity, and any electrically conductive material may be used as a conductive material unless it causes a chemical change. Examples of the conductive material include a carbon-based material, e.g., natural graphite, artificial graphite, carbon black, acetylene black, ketjen black, a carbon fiber, and the like; a metal-based material of a metal powder or a metal fiber including, e.g., copper, nickel, aluminum, silver, and the like; a conductive polymer, e.g., a polyphenylene derivative; or a mixture thereof.

The current collector may include, e.g., aluminum foil, nickel foil, or a combination thereof.

The positive active material layer and the negative active material layer may be prepared by mixing an active material, a binder, and optionally a conductive material in a solvent to prepare an active material composition and coating the active material composition on a current collector. The solvent may be, e.g., N-methylpyrrolidone. Furthermore, if the aqueous binder is used in the negative active material layer, the solvent may be water as a solvent used in the negative active material composition preparation.

The electrolyte includes a non-aqueous organic solvent and a lithium salt. The non-aqueous organic solvent serves as a medium for transmitting ions taking part in the electrochemical reaction of a battery. The non-aqueous organic solvent may include, e.g., a carbonate-based, ester-based, ether-based, ketone-based, alcohol-based, or aprotic solvent.

The carbonate-based solvent may include, e.g., dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may include, e.g., methyl acetate, ethyl acetate, n-propyl acetate, dimethyl acetate, methyl propionate, ethyl propionate, propyl propionate decanolide, mevalonolactone, caprolactone, and the like. The ether-based solvent may include, e.g., dibutyl ether, tetraglyme, diglyme, dimethoxyethane, 2-methyltetrahydrofuran, tetrahydrofuran, and the like. Furthermore, the ketone-based solvent may include, e.g., cyclohexanone, and the like. The alcohol-based solvent may include, e.g., ethyl alcohol, isopropyl alcohol, and the like, and examples of the aprotic solvent may include nitriles, e.g., R-CN (where R is a C2 to C20 linear, branched, or cyclic hydrocarbon, and may include a double bond, an aromatic ring, or an ether bond), amides (e.g., dimethylformamide), dioxolanes (e.g., 1,3-dioxolane), sulfolanes, and the like.

The organic solvent may be used alone or in a mixture. When the organic solvent is used in a mixture, the mixture ratio may be controlled in accordance with desirable battery performance.

Furthermore, the carbonate-based solvent may desirably include a mixture with a cyclic carbonate and a linear carbonate. The cyclic carbonate and the linear carbonate are mixed together in a volume ratio of about 1:1 to about 1:9, and when the mixture is used as an electrolyte, it may have enhanced performance.

When the non-aqueous organic solvents are mixed and used, a mixed solvent of a cyclic carbonate and a linear carbonate, a mixed solvent of a cyclic carbonate and a propionate-based solvent, or a mixed solvent of a cyclic carbonate, a linear carbonate, and a propionate-based solvent may be used. The propionate-based solvent may include methyl propionate, ethyl propionate, propyl propionate, or a combination thereof.

Herein, when a mixture of a cyclic carbonate and a linear carbonate, or a mixture of a cyclic carbonate and a propionate-based solvent, is used, it may be desirable to use it with a volume ratio of about 1:1 to about 1:9 considering the performances. Furthermore, a cyclic carbonate, a linear carbonate, and a propionate-based solvent may be mixed and used at a volume ratio of 1:1:1 to 3:3:4. The mixing ratio of the solvents may also be suitably controlled depending on the desired performances.

The organic solvent may further include an aromatic hydrocarbon-based solvent as well as the carbonate-based solvent. The carbonate-based solvent and the aromatic hydrocarbon-based solvent may be mixed together in a volume ratio of about 1:1 to about 30:1.

The aromatic hydrocarbon-based organic solvent may be an aromatic hydrocarbon-based compound represented by Chemical Formula 1.

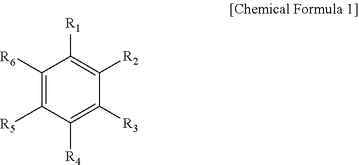

In Chemical Formula 1, R₁ to R₆ are the same or different from each other, and are selected from hydrogen, a halogen, a C1 to C10 alkyl group, a haloalkyl group, and a combination thereof.

Specific examples of the aromatic hydrocarbon-based organic solvent may be selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The electrolyte may further include vinylene carbonate, an ethylene carbonate-based compound represented by Chemical Formula 2 as an additive for improving cycle life.

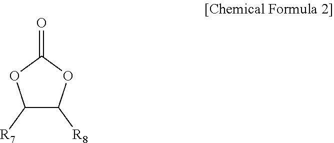

In Chemical Formula 2, R₇ and R₈ are the same or different from each other, and may each independently be hydrogen, a halogen, a cyano group (CN), a nitro group (NO₂), or a C1 to C5 fluoroalkyl group, provided that at least one of R₇ and R₈ is a halogen, a cyano group (CN), a nitro group (NO₂), or a C1 to C5 fluoroalkyl group, and R₇ and R₈ are not simultaneously hydrogen.

Examples of the ethylene carbonate-based compound may be difluoro ethylene carbonate, chloroethylene carbonate, dichloroethylene carbonate, bromoethylene carbonate, dibromoethylene carbonate, nitroethylene carbonate, cyanoethylene carbonate, or fluoroethylene carbonate. An amount of the additive for improving the cycle-life characteristics may be used within an appropriate range.

The electrolyte may further include vinyl ethylene carbonate, propane sultone, succinonitrile, or a combination thereof, and the used amount may be suitably controlled.

The lithium salt dissolved in an organic solvent supplies a battery with lithium ions, basically operates the rechargeable lithium battery, and improves transportation of the lithium ions between a positive electrode and a negative electrode. Examples of the lithium salt include at least one or two supporting salt, e.g., LiPF₆, LiBF₄, LiSbF₆, LiAsF₆, LiN(SO₂C₂F₅)₂, Li(CF₃SO₂)₂N, LiN(SO₃C₂F₅)₂, LiF(SO₂)₂N (lithium bis(fluorosulfonyl)imide: LiFSI), LiC₄F₉SO₃, LiClO₄, LiAlO₂, LiAlCl₄, LiPO₂F₂, LiN(CₓF₂ₓ₊₁SO₂)(C_{y}F_{2y+1}SO₂), wherein x and y are natural numbers, for example, an integer of 1 to 20, lithium difluoro(bisoxolato) phosphate), LiCl, LiI, LiB(C₂O₄)₂ (lithium bis(oxalato) borate: LiBOB), and lithium difluoro(oxalato)borate (LiDFOB). A concentration of the lithium salt may range from about 0.1 M to about 2.0 M. When the lithium salt is included at the above concentration range, an electrolyte may have excellent performance and lithium ion mobility due to optimal electrolyte conductivity and viscosity.

A separator may be disposed between the positive electrode and the negative electrode depending on a type of a rechargeable lithium battery. The separator may use, e.g., polyethylene, polypropylene, polyvinylidene fluoride or multi-layers thereof having two or more layers, and may be a mixed multilayer, e.g., a polyethylene/polypropylene double-layered separator, a polyethylene/polypropylene/polyethylene triple-layered separator, a polypropylene/polyethylene/polypropylene triple-layered separator, and the like.

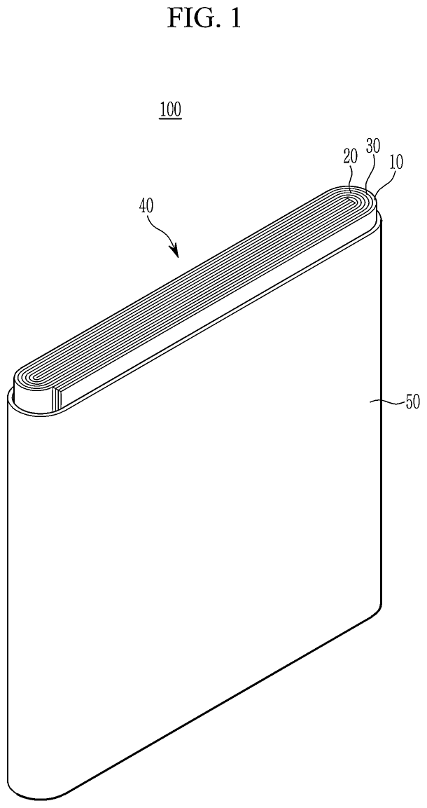

FIG. 1 is an exploded perspective view of a rechargeable lithium battery according to an embodiment. The rechargeable lithium battery according to an embodiment is illustrated as a prismatic battery but is not limited thereto, e.g., may be a cylindrical battery, a pouch battery, and the like.

Referring to FIG. 1, a rechargeable lithium battery 100 according to an embodiment may include an electrode assembly 40 manufactured by winding a separator 30 disposed between a positive electrode 10 and a negative electrode 20, and a case 50 housing the electrode assembly 40. An electrolyte may be impregnated in the positive electrode 10, the negative electrode 20, and the separator 30.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

(Example 1)

Mg₂Si was oxidized by heat-treating it at 550° C. to 650° C. under an air atmosphere to prepare a mixture of MgO and Si, and an etching procedure was performed by immersing the mixture in hydrochloric acid for about 8 hours to remove MgO, thereby obtaining porous silicon with porosity of 48.1% and including macropores with a pore size of a mode of 100 nm or more and 150 nm or less (measured by pore distribution from Barrett-Joyner-Halenda (BJH) analysis obtained by measuring adsorption and desorption of nitrogen gas). The porous silicon was mixed with soft carbon at a weight ratio of 75:25, and the mixture was heat-treated for 950° C. under a nitrogen atmosphere for 1 hour to prepare a negative active material.

The negative active material was used as a first negative active material, and natural graphite was used as a second negative active material, such that the first negative active material, the second negative active material, a styrene butadiene rubber binder, and carboxymethyl cellulose as a thickener were mixed at a 96:3:1 weight ratio in a water solvent to prepare a negative active material slurry. The negative active material slurry was coated on a Cu foil current collector, and dried and compressed by the general procedure to prepare a negative electrode including the current collector and a negative active material layer formed on the current collector.

Using the negative electrode, a LiCoO₂ positive electrode, and an electrolyte, a rechargeable lithium cell was fabricated. The electrolyte was 1.5M LiPF₆ dissolved in a mixed solvent of ethylene carbonate, ethyl methyl carbonate and dimethyl carbonate (20:10:70 volume ratio).

(Example 2)

A negative active material was prepared by the same procedure as in Example 1, except that the porous silicon was mixed with soft carbon at a weight ratio of 80:20. Using the negative active material as a first negative active material, a negative electrode and a rechargeable lithium cell was fabricated by the same procedure as in Example 1.

(Example 3)

Silicon was mixed with sodium chloride (NaCl) as a pore former at a weight ratio of 5:1, and the mixture was dispersed in an acetone solvent to prepare a dispersed liquid. The dispersed liquid was spray-dried at 180° C. to prepare a mixed product. The mixed product was added to water to dissolve the pore former, thereby removing the pore former. According to the procedure, porous silicon including macropores with a pore size of a mode of 100 nm or more was prepared. A negative active material was prepared by the same procedure as in Example 1, except that the porous silicon was mixed with soft carbon at a weight ratio of 80:20. Using the negative active material as a first negative active material, a negative electrode and a rechargeable lithium cell was fabricated by the same procedure as in Example 1.

(Example 4)

A negative active material was prepared by the same procedure as in Example 1, except that the porous silicon was mixed with soft carbon at a weight ratio of 70:30. Using the negative active material as a first negative active material, a negative electrode and a rechargeable lithium cell was fabricated by the same procedure as in Example 1.

(Comparative Example 1)

A negative active material was prepared by the same procedure as in Example 1, except that the porous silicon prepared in Example 1 was used as a first negative active material.

(Comparative Example 2)

A negative active material was prepared by the same procedure as in Example 1, except that the porous silicon was mixed with soft carbon at a weight ratio of 94:6. Using the negative active material, a negative electrode and a rechargeable lithium cell was fabricated by the same procedure as in Example 1.

(Comparative Example 3)

A negative active material was prepared by the same procedure as in Example 1, except that the porous silicon was mixed with soft carbon at a weight ratio of 57:43. Using the negative active material as a first negative active material, a negative electrode and a rechargeable lithium cell was fabricated by the same procedure as in Example 1.

(Comparative Example 4)

A negative active material was prepared by the same procedure as in Example 1, except that the porous silicon was mixed with soft carbon at a weight ratio of 47:53. Using the negative active material as a first negative active material, a negative electrode and a rechargeable lithium cell was fabricated by the same procedure as in Example 1.

(Comparative Example 5)

A negative active material was prepared by the same procedure as in Example 1, except that porous silicon with a mode of 40 nm was mixed with soft carbon at a weight ratio of 80:20. Using the negative active material as a first negative active material, a negative electrode and a rechargeable lithium cell was fabricated by the same procedure as in Example 1.

The porous silicon with the mode of 40 nm was prepared by heat-treating Mg₂Si at 700° C. under an air atmosphere to oxidize and to prepare a mixture of MgO and Si, and etching by immersing the mixture in hydrochloric acid for 8 hours to remove MgO.

(Comparative Example 6)

A negative active material was prepared by the same procedure as in Example 1, except that a porous silicon with a mode of 400 nm was mixed with soft carbon at a weight ratio of 80:20. Using the negative active material as a first negative active material, a negative electrode and a rechargeable lithium cell was fabricated by the same procedure as in Example 1.

The porous silicon with the mode of 40 nm was prepared by heat-treating Mg₂Si at 540° C. under an air atmosphere to oxidize and to prepare a mixture of MgO and Si, and etching by immersing the mixture in hydrochloric acid for 8 hours to remove MgO.

(Comparative Example 7)

A negative active material was prepared by the same procedure as in Example 1, except that the porous silicon was mixed with crystalline carbon at a weight ratio of 75:25. Using the negative active material as a first negative active material, a negative electrode and a rechargeable lithium cell was fabricated by the same procedure as in Example 1.

(Comparative Example 8)

A soft carbon liquid (prepared by adding 1 g of soft carbon to 100 ml of a tetrahydrofuran solvent) was liquid-coated on the porous silicon prepared in Example 1 by spray-drying. The resulting product was heat-treated at 950° C. for 1 hour under a nitrogen atmosphere. In the negative active material, a mixing ratio of the porous silicon and soft carbon was 75:25 weight ratio. Using the negative active material as a first negative active material, a negative electrode and a rechargeable lithium cell was fabricated by the same procedure as in Example 1.

Experimental Example: Measurement of Pore Size and Porosity

The pore sizes formed in the negative active materials according to Examples 1 to 4 and Comparative Examples 1 to 8 were measured as a mode in the pore distribution via BJH analysis method. The results are shown in Table 1.

The SEM photographs for the negative active material layers according to Examples 1 to 4 and Comparative Examples 1 to 8 were measured, and porosities were obtained from the contrast difference in the cross-section of the SEM photographs. The results are shown in Table 1.

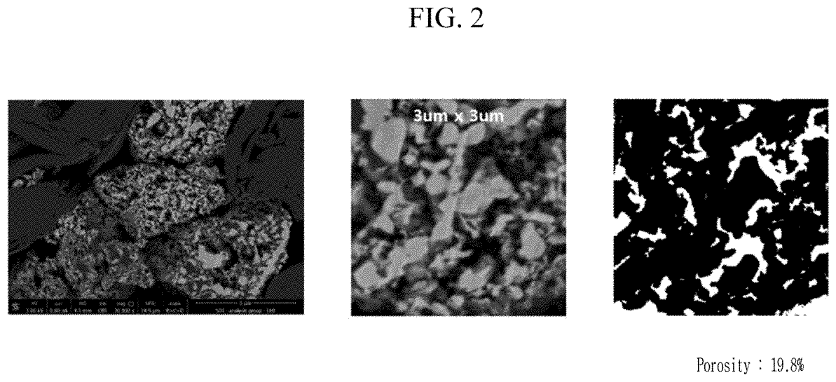

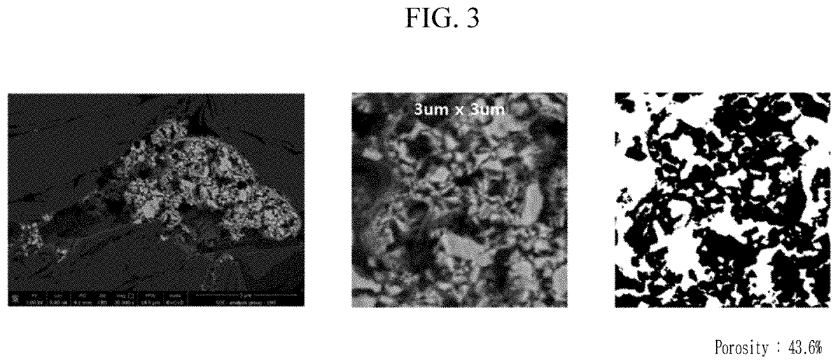

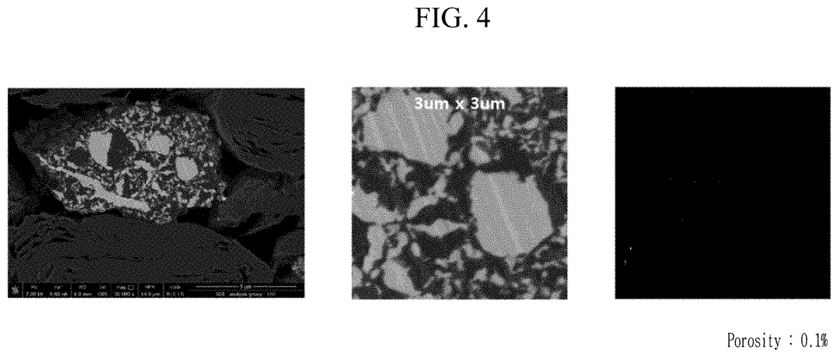

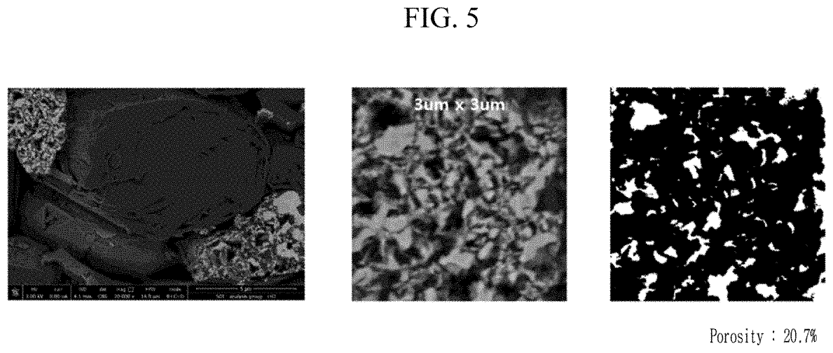

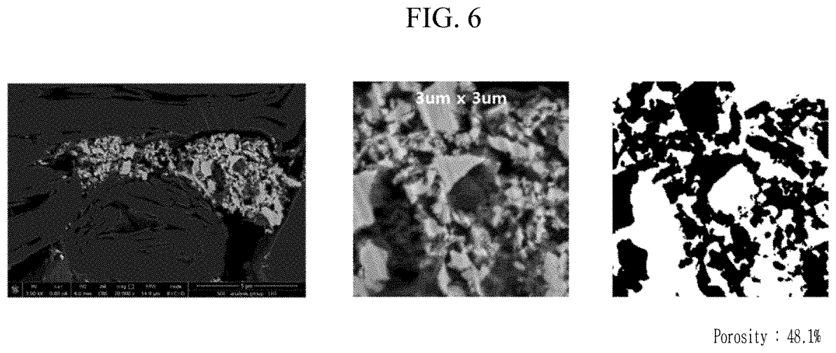

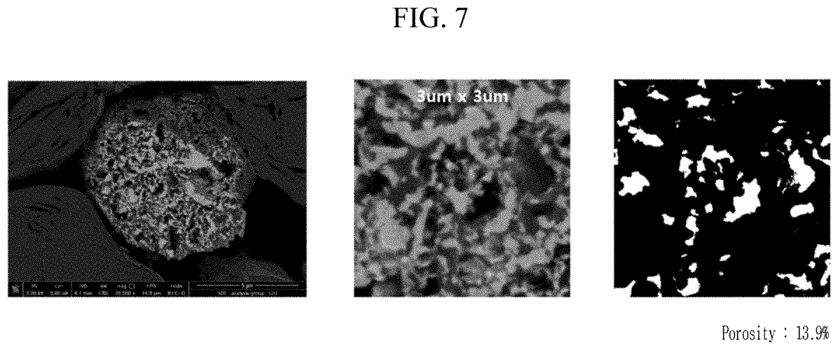

The procedures for obtaining pores from the SEM photograph are shown in FIG. 2 to FIG. 7 (FIG. 2: Example 4, FIG. 3: Comparative Example 2, FIG. 4: Comparative Example 4, FIG. 5: Example 1, FIG. 6: Comparative Example 1, FIG. 7: Comparative Example 3).

As shown in FIG. 2 to FIG. 7, an area corresponding to a unit area of 3 μm×3 μm was obtained in the measured SEM photograph, silicon, amorphous carbon, and pores were separated from the area, and porosity was obtained. That is, the bright portion indicated silicon, the grey portion indicated amorphous carbon, and the dark portion indicated pores. An area % of the darkened portion to the total area was measured as porosity.

Experimental Example: Initial Efficiency

Rechargeable lithium cells according to Examples 1 to 4 and Comparative Examples 1 to 8 were charged and discharged once at 0.2 C and initial efficiency, a ratio of discharge capacity to charge capacity, was measured.

Experimental Example: Cycle-Life Characteristic

Rechargeable lithium cells according to Examples 1 to 4 and Comparative Example 1 to 8 were charged and discharged at 0.2 C for 50 cycles, and capacity retention, 50^{th} discharge capacity to 1^{st} discharge, was measured.

TABLE 1

| | | | Amount of | | |
|---|---|---|---|---|---|
| | Pore | | carbon in | Initial | Capacity |
| | size | Porosity | silicon-carbon | efficiency | retention |
| | (nm) | (%) | composite (wt %) | (%) | (%) |
| Example 1 | 100 | 20.7 | 25 | 87.5 | 85 |
| Example 2 | 100 | 34.9 | 20 | 87.7 | 86 |
| Example 3 | 100 | 39.4 | 20 | 87.3 | 84 |
| Example 4 | 100 | 19.8 | 30 | 86.8 | 85 |
| Comparative | 100 | 48.1 | 0 | 80.1 | 73 |
| Example 1 | | | | | |
| Comparative | 100 | 43.6 | 6 | 81.5 | 68 |
| Example 2 | | | | | |
| Comparative | 100 | 13.9 | 43 | 82.5 | 71 |
| Example 3 | | | | | |
| Comparative | 100 | 0.1 | 53 | 80.4 | 70 |
| Example 4 | | | | | |
| Comparative | 40 | 18.3 | 20 | 79.2 | 74 |
| Example 5 | | | | | |
| Comparative | 400 | 41.7 | 20 | 75.3 | 52 |
| Example 6 | | | | | |
| Comparative | 100 | 22.0 | 25 | 87.0 | 55 |
| Example 7 | | | | | |
| Comparative | 25 | 13.3 | 25 | 84.2 | 66 |
| Example 8 | | | | | |

As shown in Table 1, the rechargeable lithium cells using the negative active materials according to Examples 1 to 4 exhibited excellent initial efficiency and capacity retention, as compared to those of Comparative Examples 1 to 8.

By way of summation and review, the negative active material of the rechargeable lithium battery may include a crystalline carbonaceous material, e.g., natural graphite or artificial graphite, or an amorphous carbon material. However, the carbonaceous material may exhibit a low capacity of about 360 mAh/g.

While research is performed for silicon-based materials with a capacity of four times or more that of the carbonaceous material, the silicon-based negative active material has a volume charge of about 300% or more during charge and discharge, so that repeated charging and discharging cycles may cause cracking and crumbling. Thus, the electron transference path may be broken and the SEI (solid electrolyte interface) film may be continuously formed, thereby deteriorating the cycle-life characteristics of the rechargeable lithium battery.

In contrast, according to embodiments, a negative active material for a rechargeable lithium battery exhibiting high capacity and high efficiency with improved cycle-life characteristics may be provided. Embodiments also provide a rechargeable lithium battery including the negative active material. The negative active material for the rechargeable lithium battery may exhibit excellent initial efficiency and cycle-life characteristics

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A negative active material for a rechargeable lithium battery, the negative active material comprising:
a composite of porous silicon and amorphous carbon, the composite of porous silicon and amorphous carbon having macropores with a size of about 50 nm or more, and a porosity of about 15% to about 40%.

2. The negative active material for a rechargeable lithium battery as claimed in claim 1, wherein an amount of the amorphous carbon is about 5 wt % to about 50 wt %, based on a total 100 wt % of the negative active material.

3. The negative active material for a rechargeable lithium battery as claimed in claim 1, wherein the porosity is about 20% to about 40%.

4. The negative active material for a rechargeable lithium battery as claimed in claim 1, wherein the macropores have a size of about 50 nm to about 300 nm.

5. The negative active material for a rechargeable lithium battery as claimed in claim 1, wherein an amount of the porous silicon is about 50 wt % to about 95 wt %, based on a total of 100 wt % of the negative active material.

6. The negative active material for a rechargeable lithium battery as claimed in claim 1, wherein the composite of porous silicon and amorphous carbon is a heat-treated composite.

7. A rechargeable lithium battery, comprising:
a negative electrode including the negative active material as claimed in claim 1;
a positive electrode including a positive active material; and
a non-aqueous electrolyte.
